(19) United States
(12) Patent Application Publication
(10) Pub. No.: US 2025/0073814 A1
(43) Pub. Date: Mar. 6, 2025

(54) DIRECTED COOLANT FLOWS IN A NOZZLE FOR A LASER PROCESSING SYSTEM

(71) Applicant: Hypertherm, Inc., Hanover, NH (US)

(72) Inventors: Brenda Melius, Acworth, NH (US); Kenneth J. Woods, New London, NH (US); David Cook, Bradford, VT (US)

(21) Appl. No.: 18/824,296

(22) Filed: Sep. 4, 2024

Related U.S. Application Data
(60) Provisional application No. 63/536,569, filed on Sep. 5, 2023.

(51) Int. Cl. B23K 26/14

(52) U.S. Cl. CPC B23K 26/1462

(57) ABSTRACT

A nozzle for a laser processing system is provided. A primary passage extends between the proximal end and the distal end of the nozzle body along a central longitudinal axis. At least one auxiliary passage is located within the body of the nozzle adjacent to the primary passage while substantially fluidly isolated from the primary passage. At least one conduit is located proximate the distal end of the body and in fluid communication with the at least one auxiliary passage. The at least one auxiliary passage is configured to flow a secondary fluid through the body of the nozzle in a first direction to impinge on a surface of the at least one conduit that is proximate the primary passage. The at least one conduit is configured to redirect the secondary fluid toward an exterior surface of the body in a second direction.

### CROSS REFERENCE TO RELATED APPLICATION

This application claims the benefit of and priority to U.S. Provisional Patent Application No. 63/536,569 filed on Sep. 5, 2023, the entire content of which is owned by the assignees of the instant application and incorporated herein by reference in its entirety.

### TECHNICAL FIELD

The present invention generally relates to one or more nozzle designs for a laser processing system.

### BACKGROUND

Material processing systems, including laser processing systems, liquid jet processing systems and plasma arc torch systems, are widely used for processing (e.g., heating, cutting, gouging and marking) of materials, such as metal sheets. A laser processing system generally includes a high-power laser, a gas stream, an optical system, and a computer controlled numeric system (CNC). In operation, laser processing systems use the gas stream to blow molten material away from a workpiece while controllably delivering the laser beam to the workpiece to process the workpiece. Laser processing systems are frequently used in precision cutting operations due to the ease of control provided by the laser beam, gas stream, and geometry of the laser nozzles.

Laser processing systems utilize increasing amounts of power to process (e.g., cut) thicker materials. This increase in power is adapted to produce more power in the edges of the laser beams, which interact with the walls of the laser nozzles, thereby increasing heat absorption by the nozzles and holders. In general, the laser industry safety standards restrict the temperature of the nozzles and holders to not exceed 85° C. (and a functional limit of 130° C.). FIG. 1 shows a prior-art nozzle for a laser processing system. As shown, the laser nozzle 100 includes a central bore 102 for conducting a laser beam 104 therethrough during laser operations. Most of the wall of the central bore 102 absorbs heat from the laser beam during operation.

As laser nozzles are mostly fabricated from highly thermally conductive materials, the temperature of all surfaces of a nozzle are close to equal. FIG. 2 shows an exemplary thermal image of a cross-sectional view of the prior art laser nozzle 100 of FIG. 1 during operation. The thermal image is taken after applying a constant temperature boundary condition of 200° C. to the nozzle 100, which can be safely introduced by a laser during operation. The thermal imaging analysis of FIG. 2 shows that substantially the entire nozzle 100, including the mating thermally conductive components, is about 200° C. given steady state conditions. However, surrounding ambient and cutting fluid inlet temperature(s) are equal to about room temperature (e.g., 26° C.). Therefore, it is well understood that a laser nozzle can become very hot during torch operations, especially with the increase in power usage of laser beams to process thicker materials.

Laser nozzle manufacturers have tried adding channels for a coolant (e.g., air or water) to impinge on a horizontal (or nearly horizontal) flange relative to the longitudinal axis of the nozzle (e.g., longitudinal axis A of nozzle 100 of FIG. 1). Other designs include introducing fluid jets from the nozzle holder to impinge on the back surface of the nozzle to try to provide some degree of cooling. The problem with these designs is that they are not efficient or effective for cooling at higher laser power. Additionally, during operation the cooling fluid can be entrained into the laser beam which results in substandard cut qualities. Yet some laser nozzle designs have attempted to utilize a water-cooling mist on the nozzle and/or to cool the workpiece itself. However, water can be problematic in laser cutting due to optical reflection, interference with the capacitive height sensing system, and complexity of adding a leak-free water delivery system (including pumps, hoses, misting apparatus, etc.), which can potentially lead to premature rusting of the parts being cut.

Thus, there is a need for nozzles of laser processing systems with improved cooling features without sacrificing cut qualities.

### SUMMARY

As the power level of industrial laser processing systems continues to increase, the nozzles of these systems require improved and enhanced cooling to maintain nozzle life and meet safety requirements. The present invention, in some embodiments, provides nozzles for laser cutting applications that incorporate carefully designed features, such as fluid passages formed in the nozzles, to cool the nozzles during operation. In some embodiments, these laser cutting nozzles with enhanced cooling features increase nozzle surface exposure to and interaction with coolant flows.

In one aspect, a nozzle for a laser processing system is provided. The nozzle includes a body defining a proximal end, a distal end and a central longitudinal axis extending therebetween and a primary passage extending between the proximal end and the distal end of the body along the central longitudinal axis. The primary passage is configured to flow a primary fluid along with a laser beam from the laser processing head to a workpiece. The nozzle also includes at least one auxiliary passage located within the body of the nozzle adjacent to the primary passage while substantially fluidly isolated from the primary passage and at least one conduit located proximate the distal end of the body and in fluid communication with the at least one auxiliary passage. The at least one auxiliary passage is configured to flow a secondary fluid through the body of the nozzle in a first direction to impinge on a surface of the at least one conduit that is proximate the primary passage. The at least one conduit is configured to redirect the secondary fluid toward an exterior surface of the body in a second direction. An axial component of the first direction along the central longitudinal axis is substantially opposite of an axial component of the second direction along the central longitudinal axis.

In another aspect, a method is provided for cooling a nozzle of a laser processing system. The nozzle comprises a body that defines a proximal end, a distal end and a central longitudinal axis extending therebetween. The method includes delivering a laser beam to a workpiece via a primary message extending between the proximal end and the distal end of the body of the nozzle along the central longitudinal axis. The method also includes flowing a primary fluid through the primary message to substantially shroud the laser beam and flowing, in a first direction, a cooling fluid through at least one auxiliary passage located within the body of the nozzle adjacent to the primary passage. The cooling fluid flow is substantially isolated from the primary fluid flow. The method additionally includes impinging the cooling fluid from the at least one auxiliary passage on a surface of at least one conduit located proximate the distal end of the body and in fluid communication with the at least one auxiliary passage. The method further includes redirecting by the at least one conduit, in a second direction, the cooling fluid toward an exterior surface of the body of the nozzle. The second direction has an axial component along the central longitudinal axis that is substantially opposite from an axial component of the first direction of the cooling fluid flow through the at least one auxiliary passage. In some embodiments, the first direction of the cooling fluid flow through the at least one auxiliary passage comprises a radial component directed radially inward toward the central longitudinal axis and the axial component of the first direction directed distal toward the distal end of the nozzle. In some embodiments, the second direction of the cooling fluid redirected by the at least one conduit comprises a radial component directed radially outward from the central longitudinal axis and the axial component of the second direction directed proximal toward the proximal end of the nozzle.

Any of the above aspects can include one or more of the following features. In some embodiments, the at least one auxiliary passage is oriented to direct the secondary fluid to flow radially inward toward the central longitudinal axis and axially distal toward the distal end of the nozzle. In some embodiments, the at least one auxiliary passage includes one or more expansion portions and one or more compression portions, each expansion portion shaped to allow the secondary fluid flow to expand and each compression portion shaped to constrict the secondary fluid flow. In some embodiments, the one or more compression portions or the one or more expansion portions of the at least one auxiliary passage are defined by one or more tapered or stepped configurations. In some embodiments, each compression portion is located proximate the primary passage and shaped to produce a converging jet of the secondary fluid adapted to impinge on the surface of the at least one conduit proximate the primary passage.

In some embodiments, the at least one auxiliary passage forms a tortuous path through the body of the nozzle substantially adjacent to the primary passage while creating multiple cooling impingement locations within the nozzle body, wherein the multiple cooling impingement locations are isolated from the primary passage. In some embodiments, the multiple cooling impingement locations comprise a plurality of internal surfaces of the at least one auxiliary passage to form an oscillating flow of the secondary fluid, such that the oscillating flow is configured to bounce from one internal surface to another internal surface along the auxiliary passage.

In some embodiments, the at least one auxiliary passage comprises a plurality of auxiliary passages distributed about the primary passage and substantially fluidly isolated from the primary passage. In some embodiments, the nozzle includes an inner nozzle component and an outer nozzle component, where a first subset of the plurality of auxiliary passages are located within the inner nozzle component and configured to direct internal impingement of the secondary fluid within the inner nozzle component for thermally regulating the inner nozzle component. In some embodiments, the first subset of auxiliary passages comprises cooling features in the form of at least one of a spiral groove, fin, arcuate surface, scallop, scooped pocket or textured surface located within the inner nozzle component. In some embodiments, a second subset of the auxiliary passages are disposed in the outer nozzle component and in fluid communication with the at least one conduit. The second subset of auxiliary passages are configured to direct the secondary fluid, received from the first subset of auxiliary passages, to impinge within and thermally regulate the outer nozzle component. In some embodiments, one or more auxiliary passages in the plurality of auxiliary passages are configured to return at least a portion of the secondary fluid back upstream to conserve the secondary fluid.

In some embodiments, the at least one conduit is configured to redirect the secondary fluid from the at least one auxiliary passage radially outward from the central longitudinal axis and axially proximal toward the proximal end of the nozzle. In some embodiments, the at least one conduit is configure to redirect the secondary fluid to impinge on an exterior surface of the body of the nozzle. In some embodiments, the at least one conduit is configured to redirect the secondary fluid flow outward and proximal at an angle of between about 10 degrees and about 80 degrees relative to the central longitudinal axis. In some embodiments, the at least one conduit is a collar disposed around a circumference of the nozzle body proximate to the distal end of the body, the collar being in fluid communication with the at least one auxiliary passage. In some embodiments, the at least one conduit comprises at least one hole in fluid communication with the at least one auxiliary passage. In some embodiments, the at least one conduit defines an angled slot between the distal end of the nozzle and a portion of the exterior surface of the nozzle. The slot can have a width that is greater than a diameter of the at least one auxiliary passage. A radius of curvature of a bottom region of the slot can be less than about 55% of the width of the slot.

In some embodiments, the at least one conduit blocks a line of sight between an outlet of the at least one auxiliary passage and an intersection between a laser beam delivered by the primary passage and the workpiece. In some embodiments, the at least one auxiliary passage or the at least one conduit is created by an insert disposed within the body of the nozzle. In some embodiments, the at least one auxiliary passage or the at least one conduit is created by one or more of press fit, machining grooves, friction welding, diffusion bonding, or three-dimensional printing.

In some embodiments, an area of the exterior surface of the body in contact with the secondary fluid redirected by the at least one conduit is greater than or equal to about 30% of a total external surface area of the nozzle. In some embodiments, the secondary fluid comprises a coolant fluid and the area of the exterior surface in contact with the secondary fluid extracts greater than about 0.05 watts/cubic-feet-per-min of coolant fluid flow. In some embodiments, the secondary fluid has a composition different from that of the primary fluid. In some embodiments, at least a portion of the secondary fluid is helium or air.

In some embodiments, the primary passage has a cross-sectional area of between about 1.5 mm² and 5 mm², and the at least one auxiliary passage has a cross-sectional area of between about 10 mm² and 25 mm². In some embodiments, a ratio of a cross-sectional area of the primary passage to a cross-sectional area of the at least one auxiliary passage is about 0.5 or less.

In some embodiments, the nozzle further includes at least one vent passage disposed about the primary passage and located at the proximal end of the body of the nozzle. The at least one vent passage is configured to vent at least a portion of the secondary fluid to atmosphere.

In some embodiments, a first subset of the at least one auxiliary passage are configured to conduct the secondary fluid through the body of the nozzle and a second subset of the at least one auxiliary passage are configured to conduct a tertiary fluid through the body of the nozzle. In some embodiments, the secondary fluid comprises a first cooling fluid and the tertiary fluid comprises a second cooling fluid. In some embodiments, the first cooling fluid is a gas and the second cooling fluid is a liquid. In some embodiments, the second cooling fluid is circulated back to the laser processing head while the first cooling fluid is exhausted from the nozzle to atmosphere.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a prior-art nozzle for a laser processing system.

FIG. 2 shows an exemplary thermal image of a cross-sectional view of the prior art laser nozzle of FIG. 1 during operation.

FIGS. 3a and 3b show a sectional perspective view and a sectional side view, respectively, of an exemplary nozzle for a laser processing system, according to some embodiments of the present invention.

FIG. 4 shows a portion of the nozzle of FIGS. 3a and 3b with multiple auxiliary passages, according to some embodiments of the present invention.

FIG. 5 shows a computational flow analysis for the nozzle of FIGS. 3a and 3b during a cutting operation, according to some embodiments of the present invention.

FIGS. 6a-c show various perspective views and a distal view of another nozzle for a laser processing system with added cooling features, according to some embodiments of the present inventions.

FIG. 7 shows a cross-sectional perspective view of another nozzle for a laser processing system with a different configuration of the coolant fluid exit conduit, according to some embodiments of the present inventions.

FIGS. 8a and 8b show a cross-sectional view and a partial end view, respectively, of another nozzle for a laser processing system with another configuration of the auxiliary passage(s), according to some embodiments of the present invention.

FIG. 9 shows a portion of a cross-sectional view of another nozzle for a laser processing system with yet another configuration of the auxiliary passage(s), according to some embodiments of the present invention.

FIG. 10 shows a cross-sectional perspective view of another nozzle of a laser processing system with auxiliary passages representing cooling features disposed in the inner nozzle component and another configuration of the fluid exit conduit in the outer nozzle component, according to some embodiments of the present invention.

FIG. 11 shows a profile view of the inner nozzle component of the nozzle of FIG. 10, according to some embodiments of the present invention.

FIG. 12 shows an alternative configuration of the inner nozzle component compatible with the nozzle of FIG. 10, according to some embodiments of the present invention.

FIG. 13 shows a sectional perspective view of another nozzle of a laser processing system with yet another configuration of the fluid exit conduit, according to some embodiments of the present invention.

FIG. 14 shows another nozzle of a laser system with auxiliary passages forming multiple tortuous/oscillating fluid flow paths within the body of the nozzle, according to some embodiments of the present invention.

FIG. 15 shows an exemplary method for operating a laser processing system incorporating the laser nozzle of FIGS. 3a and 3b, according to some embodiments of the present invention.

### DETAILED DESCRIPTION

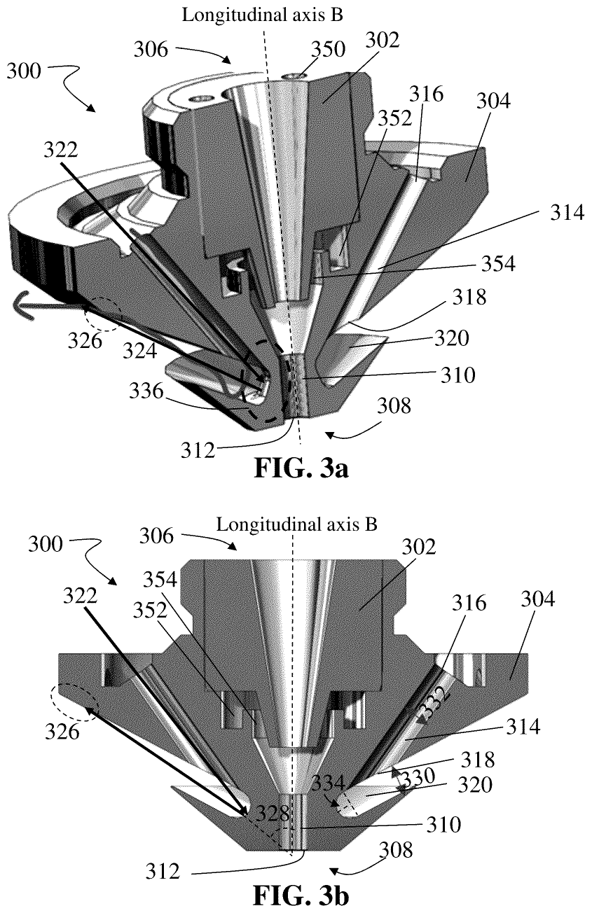

FIGS. 3a and 3b show a sectional perspective view and a sectional side view, respectively, of an exemplary nozzle 300 for a laser processing system, according to some embodiments of the present invention. As shown, the nozzle 300 is a double nozzle having an inner nozzle component 302 with an inner body and an outer nozzle component 304 with an outer body. The nozzle 300 generally comprises a proximal end 306 and a distal end 308 along a central longitudinal axis B, where the distal end 308 is defined as the end that is closest to a workpiece (not shown) during operation of the laser processing system, and the proximal end 306 is opposite of the distal end 308 along the longitudinal axis B.

A primary passage 310 is disposed in the nozzle 300, including through the bodies of the inner nozzle component 302 and the outer nozzle component 304, and extends between the proximal end 306 and the distal end 308 along central longitudinal axis B. The primary passage 310 is configured to receive a primary fluid (e.g., a gas, a liquid, or a mixture of both) from a laser processing head (not shown) of the laser processing system and deliver, via its distal opening 312, the primary fluid along with a laser beam to the workpiece, such as a piece of metal, for processing the workpiece. Therefore, the primary passage 310 serves as a combination of a laser beam bore and a primary fluid passage.

In addition, at least one auxiliary passage 314 is disposed in the nozzle 300, such as in the body of the outer nozzle component 304 of the nozzle 300. Each auxiliary passage 314 is located adjacent to the primary passage 310, while being substantially fluidly isolated from the primary passage 310. More specifically, each auxiliary passage 314 has (i) a proximal opening 316 that is radially offset from the longitudinal axis of the primary passage 310 (i.e., from central longitudinal axis B), and (ii) a distal opening 318 that is also radially offset from the longitudinal axis of the primary passage 310, but closer to central longitudinal axis B than the proximal opening 316. Therefore, each auxiliary passage 314 can be angled toward the primary passage 310, but fluidly separated from the primary passage 310.

In some embodiments, the distal opening 318 of each auxiliary passage 314 is in fluid communication with at least one fluid exit conduit located proximate the distal end 308 of the nozzle 300 adjacent to the primary passage 310. For example, as shown in FIGS. 3a and 3b, the fluid exit conduit can be a circumferential collar 320 disposed in the body of the outer nozzle component 304 substantially surrounding the primary passage 310 proximate to the distal end 308. The fluid exit conduit can have alternative configurations, such as multiple exit holes, as explained in detail below. Each auxiliary passage 314 is configured to flow a secondary fluid (e.g., a gas, a liquid, or a mixture of both) through the nozzle body from the proximal opening 316 to the distal opening 318 along a first direction 322 to impinge on a surface of the collar 320. The collar 320 is configured to receive the secondary fluid from the auxiliary passage(s) 314 and redirect substantially all of the secondary fluid toward an exterior surface of the body of the outer nozzle component 304 in a second direction 324.

In some embodiments, the axial component of the first direction 322 along central longitudinal axis B is substantially opposite of the axial component of the second direction 324 along central longitudinal axis B. Therefore, the axial component of the second direction 324 is partially to substantially opposite of the direction of flow of the primary fluid in the primary passage 310. In some embodiments, the radial component of the first direction 322 is substantially opposite of the radial component of the second direction 324. As an example, each auxiliary passage 314 can be oriented to direct the secondary fluid to flow radially inward toward central longitudinal axis B and axially distal toward the distal end 308 of the nozzle 300. The collar 320 can be configured to redirect the secondary fluid from the one or more auxiliary passages 314 radially outward relative to central longitudinal axis B and axially proximal toward the proximal end 306 of the nozzle 300. In some embodiments, the collar 320 is configured to redirect the secondary fluid flow outward and proximal at an angle 328 of between about 10 degrees and about 80 degrees, such as between about 30 degrees and about 60 degrees (e.g., about 45 degrees) relative to central longitudinal axis B (illustrated in FIG. 3b). For example, in the embodiment of FIGS. 3a and 3b, the close angle 328 between the second direction 324 of the collar 320 and longitudinal axis B of the nozzle 300 allows the secondary fluid to be redirected into impingement with an external surface 326 of the outer nozzle component 304.

In some embodiments, the secondary fluid is a coolant fluid (e.g., a coolant gas or liquid, or a mixture of the two). The coolant fluid flow does not join or assist the cutting fluid flow in a cut process, where the cutting fluid flow is conducted through the primary passage 310. However, since the coolant fluid flow is conducted by the auxiliary passage(s) 314 to be close to the primary passage 310, such as at a critical region 336 proximate the primary passage 310 as illustrated in FIG. 3a, it increases the amount of cooling experienced by the cutting fluid flow in the primary passage 310 without comingling with the cutting fluid flow. Upon the coolant fluid flow entering the collar 320, the upward angle 328 of the collar 320 directs the coolant fluid flow along the exterior surface 326 of the nozzle 300 to increase contact cooling. In some embodiments, the area of the exterior surface 326 in contact with the coolant fluid flow extracts greater than about 0.05 watts/cubic-feet-per-min of coolant fluid flow. This area of the exterior surface 326 can be greater than or equal to about 30% of the total external surface area of the nozzle 300 (e.g., the total external surface area of the outer nozzle component 304 if the nozzle is a double nozzle).

In some embodiments, the inner nozzle component 302 of the nozzle 300 also has one or more cooling features. As shown, the inner nozzle component 302 includes a set of auxiliary passages 350 dispersed circumferentially around the primary passage 310. Each auxiliary passage 350 extends substantially axially along the central longitudinal axis B and is in fluid communication with a donut-shaped circumferential chamber 352 at the interface of the inner nozzle component 302 and the outer nozzle component 304 and cooperatively defined by these two components 302, 304. In addition, a spillover passage 354 is in fluid communication with the donut-shaped circumferential chamber 352 and the primary passage 310 to conduct the fluid from the chamber 352 to the primary passage 310. During operation, a cutting fluid, such as a cutting gas, is introduced into both the primary passage 310 and the auxiliary passages 350 (e.g., the cutting gas is supplied by the cutting head of the laser processing system by segmenting the cutting gas into two flows at the nozzle interface or two separate cutting fluid supplies/flows are provided by the cutting head, etc.). The cutting gas in the auxiliary passages 350 is adapted to flow axially toward the distal end 308 of the nozzle 300 to cool the inner nozzle component 302 and enter the circumferential chamber 352. From the circumferential chamber 352, the cutting gas can spill over into the spillover passage 354 by traveling axially proximal and radially inward before again traveling axially distal within the spillover passage 354 for exhaustion into the primary passage 310. The cutting gas from the auxiliary passages 350 can be exhausted out of the primary passage 310 via opening 312 as a shroud about the laser beam. Therefore, the nozzle 300 can support both (i) an outer coolant flow in the outer nozzle component 304 that cools proximate the primary passage 310 and (ii) an inner coolant flow in the inner nozzle component 302 that cools an interior portion of the nozzle 300 and then joins/assists the cutting flow in the primary passage 310 as it is exhausted from the primary passage 310 onto the cutting surface. In some embodiments, the inner and outer coolant flows do not intermingle/cross paths.

In some embodiments, the collar 320 of FIGS. 3a and 3b defines an angled slot extending between the distal end 308 of the nozzle 300 and a portion of the exterior surface of the nozzle 300, such as the exterior surface of the outer nozzle component 304. The collar 320, which is in the form of a slot, can have a width 330 that is greater than a diameter 332 of each auxiliary passage 314. The increased width 330 of the collar 320 is adapted to enhance the cooling ability of the coolant fluid flow at the critical region 336 proximate the primary passage 310. In some embodiments, a radius of curvature 334 of the bottom region of the slot is less than about 55% of the width 330 of the slot, such as between about 5% to about 10% of the width 330. As another example, the radius can be equal to about ½ the width 330. Such a configuration improves nozzle cooling, as the collar 320 with a wider bottom that is exposed to ambient is adapted to promote sudden expansion of the coolant fluid flow (e.g., coolant gas flow) as it emerges from the auxiliary passage(s) 314, thereby reducing its temperature and increasing cooling capacity just prior to impingement on the nozzle surface in critical region 336.

In some embodiments, the primary passage 310 of the nozzle 300 has a cross-sectional area of between about 1.5 mm² and about 5 mm², while each auxiliary passage 314 has a cross-sectional area of between about 10 mm² and about 25 mm². In some embodiments, a ratio of the cross-sectional area of the primary passage 310 to a cross-sectional area of each auxiliary passage 314 is about 0.5 or less.

Even though nozzle 300 of FIGS. 3a and 3b is illustrated as a double nozzle with the inner nozzle component 302 and the outer nozzle component 304, the various cooling features in nozzle 300 can also be present in a nozzle with a single nozzle body (not shown), such as a unitary nozzle, manufactured via three-dimensional printing and/or additive manufacturing, etc., For example, the auxiliary passages 314 and the collar 320 can be similarly embedded in the body of a single nozzle proximate the primary passage 310 to provide effective cooling during a cut process.

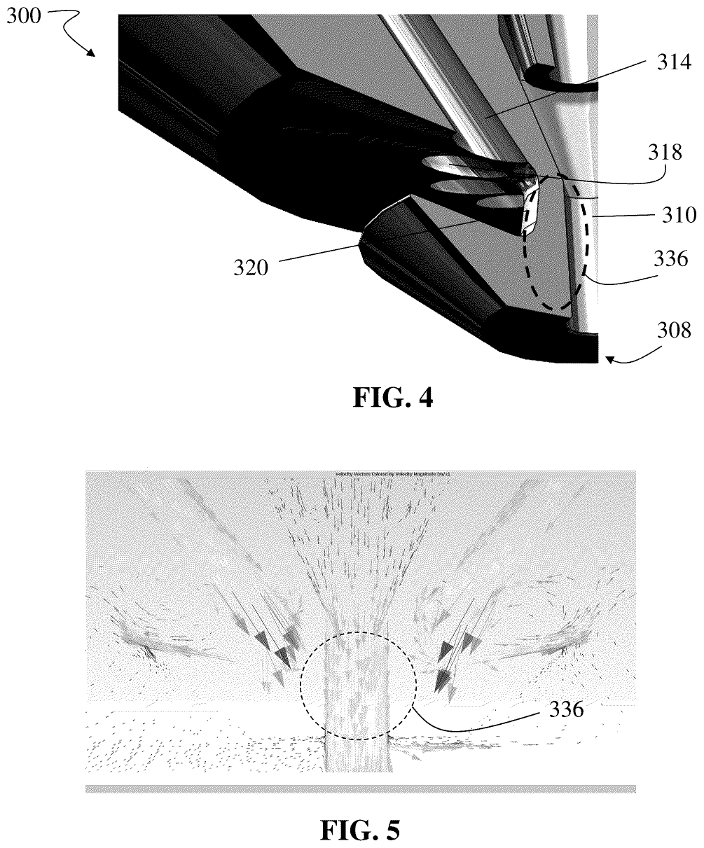

FIG. 4 shows a portion of the nozzle 300 of FIGS. 3a and 3b with multiple auxiliary passages 314, according to some embodiments of the present invention. As shown, the set of multiple auxiliary passages 314 are circumferentially interspersed about the distal end 308 of the nozzle 300 in proximity to one another while being close to the primary passage 310. The multiple auxiliary passages 314 are in fluid communication with the slotted circumferential collar 320 via their distal openings 318. Each of the multiple auxiliary passages 314 can be configured to conduct a secondary fluid flow, such as a coolant fluid flow, to radially and/or axially impinge on a wall of the collar 320, thereby increasing impingement cooling in the critical region 336 around the primary passage 310. Alternatively, a single auxiliary passage 314 can be embedded in the nozzle body to perform similar functions.

FIG. 5 shows a computational flow analysis for the nozzle 300 of FIGS. 3a and 3b during a cutting operation, according to some embodiments of the present invention. The flow analysis is generated from the process of providing a coolant fluid to the set of multiple auxiliary passages 314 via their respective proximal openings 316, where the coolant fluid is directed by each of the auxiliary passages 314 to exit into the conduit/collar 320 via their respective distal openings 318 and impinge on the critical region 336 proximate the primary passage 310. As shown, the critical region 336 of the nozzle 300 near the distal end 308 of the nozzle 300 achieves significant cooling due to the impingement cooling immediately adjacent to the primary passage 310. After impingement, the coolant fluid flow is exhausted away from the cutting fluid flow in the primary passage 310 without comingling with the cutting fluid flow. The exhaustion of the coolant fluid flow is accomplished by the angled orientation of the conduit/collar 320.

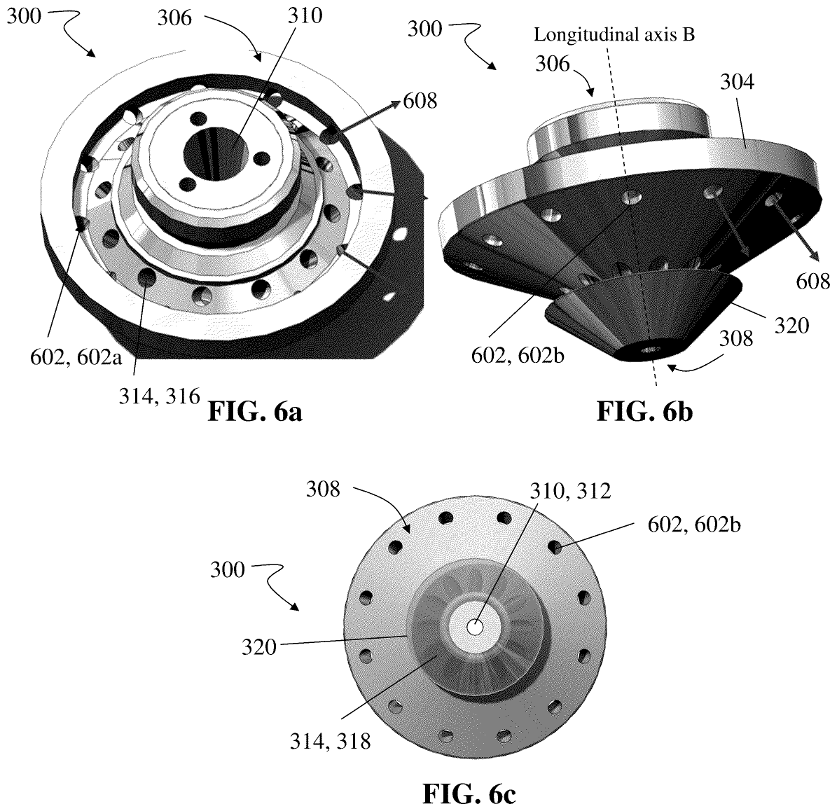

FIGS. 6a-c show various perspective views and a distal view of another nozzle 600 for a laser processing system with added cooling features, according to some embodiments of the present inventions. The nozzle 600 is similar to the nozzle 300 of FIGS. 3a and 3b, where like features of the nozzle 600 are assigned the same numerical references as those of nozzle 300 of FIGS. 3a and 3b. For nozzle 600, the additional cooling features comprise a set of one or more vent passages 602 located at the proximal end 306 of the nozzle 600, such as disposed in the body of the outer nozzle component 304. Each vent passage 602 extends between a proximal opening 602a and a distal opening 602b for venting at least a portion of the secondary fluid flow (e.g., a coolant fluid flow) outward to atmosphere along a direction 608 that is off-axis relative to the longitudinal axis B of the nozzle 600. FIG. 6b clearly shows the exhaust paths 608 of these off-axis vent passages 602. The set of off-axis vent passages 602 can be dispersed circumferentially equidistant around the primary passage 310 and around the auxiliary passages 314. In some embodiments, each proximal opening 602a of a vent passage 602 is radially located between a pair of the proximal openings 316 of the auxiliary passages 314 to further increase the amount of heat exhausted from the nozzle 600 and/or block the direct path of heating in the outer diameter of the nozzle 600. In addition, the off-axis vent passages 602 can direct the secondary fluid flow away from the cut surface/interface at the distal end 308 of the nozzle 600 to avoid interference with a cut process. Furthermore, the off-axis vent passages 602 can disrupt the tendency of the lower coolant fluid flow through the auxiliary passages 314 to form a vortex around the edge of the collar 320 and contaminate the primary fluid flow in the kerf. In operation, a portion of the secondary fluid can be supplied to the auxiliary passages 314 via their proximal openings 316 for cooling proximate the primary passage 310, while another portion of the secondary fluid can be supplied to the proximal openings 602a of the vent passages 602 for venting to atmosphere.

FIG. 6c shows a distal view of the nozzle 600 from its distal end 308. When viewed from the distal end 308, the auxiliary passages 314 are not visible (illustrated in phantom in FIG. 6c) due to the positioning and configuration of the conduit/collar 320. More specifically, the conduit/collar 320 blocks a line of sight between the distal opening 318 of each auxiliary passage 314 and an intersection between the laser beam delivered by the primary passage 310 and the workpiece. That is, when viewed from the distal end 308 of the nozzle 600, one cannot see the distal opening(s) 318 of the auxiliary passage(s) 314 because they are blocked by the angled conduit/collar 320. Therefore, the conduit/collar 320 substantially inhibits the secondary fluid flow (e.g., a coolant fluid flow) introduced by the auxiliary passages 314 from being entrained in the cutting fluid flow expelled from the distal opening 312 of the primary passage 310 for the purpose of preserving cut qualities. In some embodiments, the same lack of visibility of the auxiliary passage(s) 314 from the distal end 308 applies to nozzle 300 of FIGS. 3a and 3b.

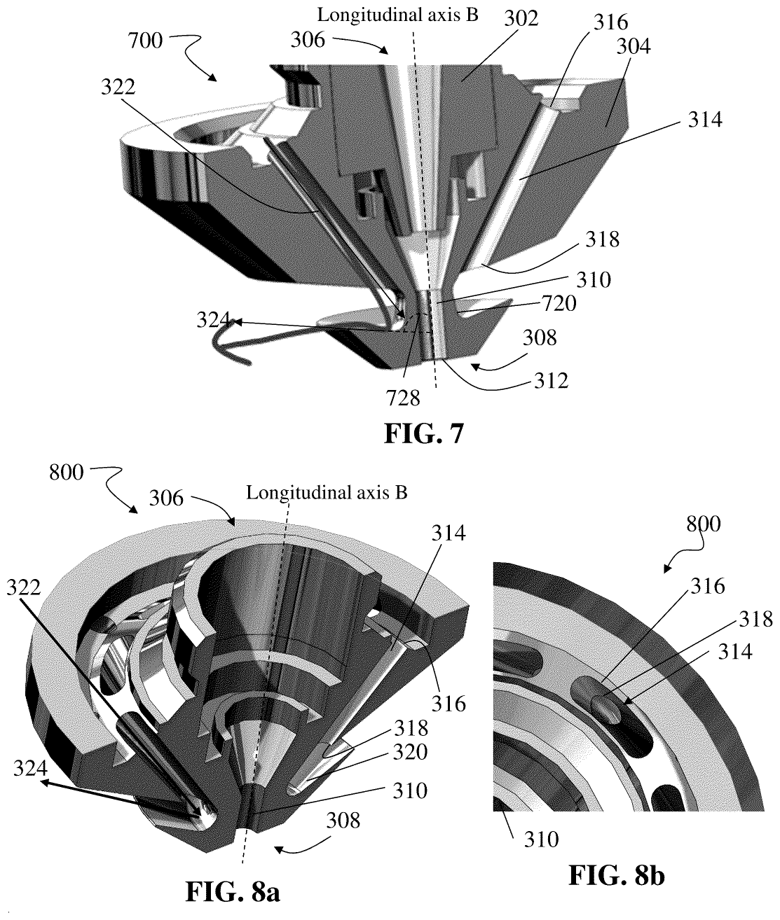

FIG. 7 shows a cross-sectional perspective view of another nozzle 700 for a laser processing system with a different coolant fluid exit conduit, according to some embodiments of the present inventions. The nozzle 700 is similar to the nozzle 300 of FIGS. 3a and 3b, where like features of nozzle 700 are assigned the same numerical references as those of nozzle 300 of FIGS. 3a and 3b. The main difference between nozzle 700 and nozzle 300 is that the coolant fluid exit conduit (i.e., collar 720) of nozzle 700 has a larger angle 728 relative to central longitudinal axis B in comparison to the angle 328 of the collar 320 of nozzle 300 FIGS. 3a and 3b.

As shown in FIG. 7, the secondary fluid flow path within the nozzle 700 includes the first fluid flow direction 322 via each auxiliary passages 314 and the second fluid flow direction 324 via the collar 720. Same as nozzle 300, the axial component of the first direction 322 along central longitudinal axis B is substantially opposite of the axial component of the second direction 324 along central longitudinal axis B. However, since angle 728 of the collar 720 of nozzle 700 is lowered from central longitudinal axis B in comparison to that of the collar 320 of nozzle 300 of FIGS. 3a and 3b, the secondary fluid makes minimal physical contact with an exterior surface of the body of the nozzle 700 (e.g., an exterior surface of the outer nozzle component 304), even though the collar 720 is angled toward the exterior surface. In some embodiments, the secondary fluid is a coolant fluid that is directed by the collar 720 of nozzle 700 to flow away from the cutting surface adjacent to the distal end 308 of the nozzle 700 to cool proximate the primary passage 310 while achieving little to no secondary cooling along an external surface of the nozzle 700. In some embodiments, the nozzle 700 of FIG. 7 also has a set of vent passages described above with reference to FIGS. 6a-c.

FIGS. 8a and 8b show a cross-sectional view and a partial end view, respectively, of another nozzle 800 for a laser processing system with another configuration of the auxiliary passage(s) 314, according to some embodiments of the present invention. The nozzle 800 is similar to the nozzle 300 of FIGS. 3a and 3b, where like features of the nozzle 800 are assigned the same numerical references as those of nozzle 300 of FIGS. 3a and 3b. For nozzle 800, each auxiliary passage 314 is tapered such that its proximal opening 316 is larger than its distal opening 318, which is clearly illustrated in FIG. 8b. The tapered auxiliary passage(s) 314 are designed to further promote and leverage the thermodynamic impact of rapidly compressing and expanding secondary fluid flow proximate the primary passage 310. More specifically, by narrowing the diameter of each auxiliary passage 314 as the auxiliary passage 314 extends distally, the secondary fluid (e.g., a coolant fluid) traveling therethrough is compressed as it moves axially distal toward the primary passage 310 to produce a converging jet of the secondary fluid. This jet of secondary fluid then rapidly expands when it enters the fluid exit conduit, such as in the form of collar 320, to impinge on the walls of the fluid exit conduit, thereby cooling the conduit walls along with the nearby primary passage 310. Even though the tapered construction of the auxiliary passage(s) 314 are present in nozzle 800 of FIGS. 8a and 8b, the same tapered configuration is applicable to the auxiliary passage(s) 314 of the nozzles of FIGS. 3a-7.

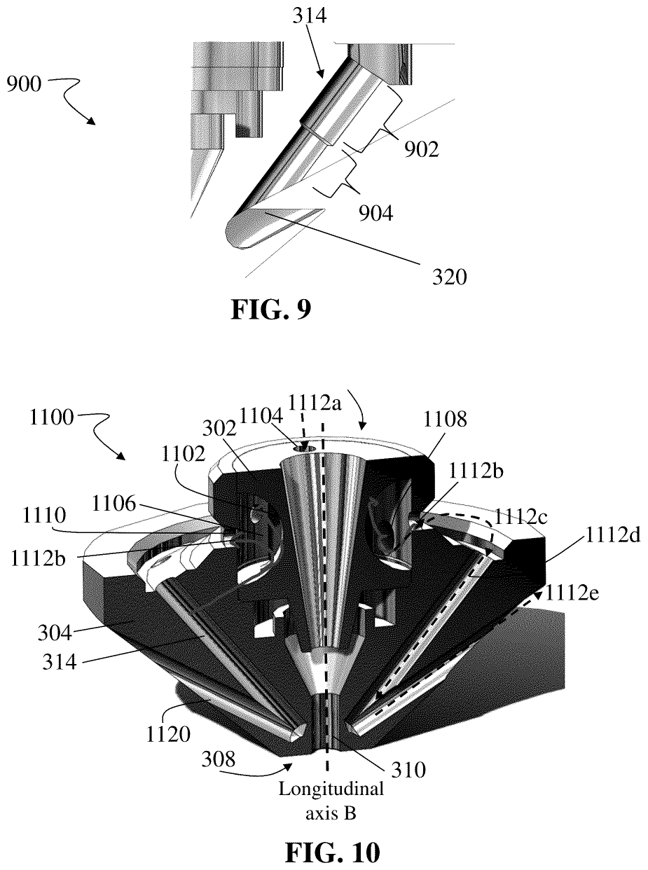

FIG. 9 shows a portion of a cross-sectional view of another nozzle 900 for a laser processing system with yet another configuration of the auxiliary passage(s) 314, according to some embodiments of the present invention. As shown, the nozzle 900 of FIG. 9 has a stepped construction of the auxiliary passages 314, where a proximal section 902 of each auxiliary passage 314 has a first diameter and a distal section 904 of each auxiliary passage 314 has a second diameter that is smaller than the first diameter. Each stepped auxiliary passage 314 (i.e., with successive narrowing diameters as the auxiliary passage 314 extends distally) is configured to compress the secondary fluid flow prior to its emergence into the fluid exit conduit, such as in the form of a collar, similar in principle to the tapered auxiliary passages 314 of FIGS. 8a and 8b. In some embodiments, the stepped auxiliary passage(s) 314 are manufactured using an alternative, more straightforward manufacturing approach in comparison to the tapered auxiliary passage(s) of FIGS. 8a and 8b while offering similar advantages. As well understood by a person of ordinary skill in the art, more than two stepped sections can be constructed for each of the auxiliary passages 314. Also, a person of ordinary skill in the art understands that the stepped construction of the auxiliary passage(s) 314 can be easily adapted to the auxiliary passage(s) of the nozzles of FIGS. 3a-8b.

In general, as explained above with reference to FIGS. 8a-9, each auxiliary passage can include one or more expansion portions and one or more compression portions, where each expansion portion is shaped to allow the secondary fluid flow to expand, and each compression portion is shaped to constrict the secondary fluid flow. In the embodiment of FIGS. 8a and 8b, the expansion and compression portions of an auxiliary passage are defined by a tapered configuration. In the embodiment of FIG. 9, the expansion and compression portions of an auxiliary passage are defined by a stepped configuration. In some embodiments, the compression portions are located more distally and more radially adjacent to the primary passage in comparison to the expansion portions, such that the secondary fluid is successively compressed as it flows axially distal and radially inward toward the distal end of the nozzle. As a result, each auxiliary passage is configured to produce a converging jet of the secondary fluid adapted to impinge on the surface of the fluid exit conduit (e.g., in the form of a collar) adjacent to the primary passage.

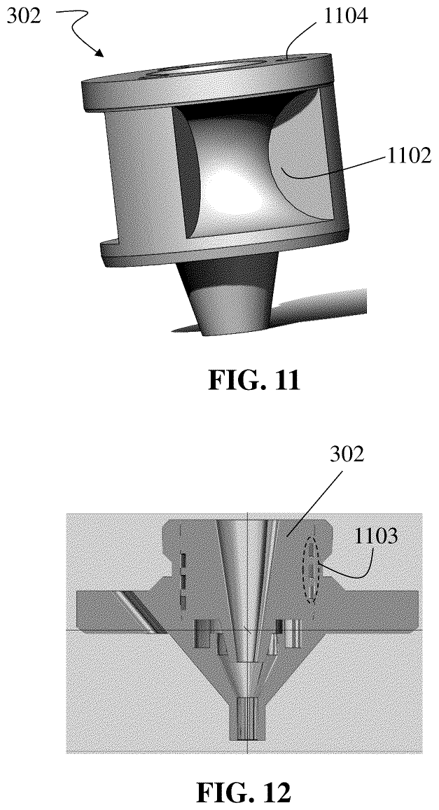

FIG. 10 shows a cross-sectional perspective view of another nozzle 1100 of a laser processing system with auxiliary passages representing cooling features disposed in the inner nozzle component 302 and another configuration of the fluid exit conduit in the outer nozzle component 304, according to some embodiments of the present invention. FIG. 11 shows a profile view of the inner nozzle component 302 of the nozzle 1100 of FIG. 10, according to some embodiments of the present invention. The double nozzle 1100 shares certain similar features with the double nozzle 300 of FIGS. 3a and 3b, where like features of the nozzle 1100 are assigned the same numerical references as those of nozzle 300. One difference between the nozzles is that the inner nozzle component 302 of the nozzle 1100 has different cooling features in comparison to the cooling features in the inner nozzle component of nozzle 300. A secondary fluid can be directed into the cooling features in the inner nozzle component 302 of the double nozzle 1100 and exit to the outer nozzle component 304 via another passage in the nozzle or a mating component, such as a cutting head (not shown). The auxiliary passages/cooling features in the inner nozzle component 302 are configured to direct internal impingement of the secondary fluid to achieve thermal regulation of the inner nozzle component 302.

More specifically, as shown in FIG. 11, the auxiliary passages/cooling features of the inner nozzle component 302 can comprise a set of scooped pockets 1102, where each scooped pocket 1102 is carved into the body of the inner nozzle component 302 from its outer surface. A secondary fluid (e.g., a coolant fluid) is adapted to flow through the scooped pockets 1102 of the inner nozzle component 302 to cool the inner nozzle component 302 prior to flowing through the auxiliary passage(s) 314 of the outer nozzle component 304 proximate the primary passage 310 and making a sharp directional turn back away from the cut surface via the fluid exit conduit in the form of multiple slotted holes 1120 for exhaustion from the outer nozzle component 304.

Even though the auxiliary passages/cooling features of the inner nozzle component 302 are illustrated as a set of scooped pockets 1102, in alternative embodiments, these inner cooling features can be one or more of spiral groove(s), fins, scallops, or other cooling passages, etc. In particular, FIG. 12 shows an alternative configuration of the inner nozzle component 302 compatible with the nozzle 1100 of FIG. 10, according to some embodiments of the present invention. As shown, instead of a set of scooped pockets 1102 as shown in FIG. 11, the inner nozzle component 302 can have a set of spiral grooves 1103 for receiving a secondary fluid (e.g., a coolant fluid) to cool the inner nozzle component 302. The spiral groves 1103 can be carved into the body of the inner nozzle component 302 from its exterior surface.

Referring back to FIG. 10, another difference between nozzle 1100 and nozzle 300 is that the fluid exit conduit located adjacent to the primary passage 310 at the distal end 308 of the nozzle 1100 for receiving and redirecting the secondary fluid from at least one auxiliary passage 314 is in the form of one or more slotted holes 1120 instead of a single circumferential collar 320. Each hole 1120 intersects the distal opening 318 of a corresponding auxiliary passage 314 to receive and redirect the secondary fluid received from the corresponding auxiliary passage 314. Therefore, if there are a plurality of auxiliary passages 314 dispersed around the primary passage 310 (as illustrated in the embodiment of FIG. 4), a plurality of holes 1120 are dispersed around a circumference of the primary passage 310 near the distal end 308 of the nozzle 1100 to intersect respective ones of the auxiliary passages 314. Each distal opening 318 of an auxiliary passage 314 is in fluid communication with its corresponding hole 1120. In some embodiments, the plurality of holes 1120 are fluidly isolated from the primary passage 310 and fluidly isolated from each other. In some embodiments, each hole 1120 is formed via a drilling process.

For the outer nozzle component 304, each of the auxiliary passage(s) 314 channels the secondary fluid flow in a first direction 1112d for impingement on a wall of the corresponding hole 1120, thereby delivering the secondary fluid close to the primary passage 310. Each hole 1120 that intersects the corresponding auxiliary passage 314 is angled to direct the fluid in a second direction 1112e toward an external surface of the nozzle 1100 to exhaust the fluid in a manner upward/proximal and toward the external surface of the nozzle 1100, away from a cut/workpiece interface at the distal end 308 of the nozzle 1100. In some embodiments, similar to the collar 320 of FIGS. 3a and 3b, the axial component of the first direction 1112d of each auxiliary passage 314 along central longitudinal axis B is substantially opposite of the axial component of the second direction 1112e along central longitudinal axis B. In some embodiments, the radial component the first direction 1112d is substantially opposite of the radial component of the second direction 1112e. Each hole 1120 can be configured to redirect the secondary fluid from its corresponding auxiliary passage 314 radially outward relative to central longitudinal axis B and axially proximal toward the proximal end 306 of the nozzle 1100 at an angle of between about 10 degrees and about 80 degrees, such as between about 30 degrees and about 60 degrees (e.g., about 45 degrees) relative to the central longitudinal axis B. For nozzle 1100 of FIG. 10, this angle is relatively small (i.e., close to longitudinal axis B), such as between about 1 and about 30 degrees, to allow the secondary fluid to be redirected into impingement with an external surface of the nozzle 1100 for cooling purposes, similar to the embodiment of FIGS. 3a and 3b. Alternatively, this angle can be relatively large (i.e., more distant from longitudinal axis B) to allow the secondary fluid to exhaust way without making physical contact with an external surface of the nozzle 1100, similar to the embodiment of FIG. 7.

FIG. 10 further illustrates an exemplary flow path 1112 of a secondary fluid, such as a coolant fluid, through the double nozzle 1100. The coolant fluid is first provided to the inner nozzle component 304 via an auxiliary passage 1104 at the proximal end 306 of the nozzle 1100 along path direction 1112a. The secondary fluid enters one of the scooped pockets 1102 of the inner nozzle component 302 to be deposited in a concave chamber 1106 defined by the scooped pocket 1102 and the interior surface of the outer nozzle component 304. The secondary fluid in the concave chamber 1106 is adapted to cool the inner nozzle component 302 proximate the laser beam in the primary passage 310 as well as the outer nozzle component 304 near the proximal end 306 of the nozzle 1100. The coolant flow then axially passes along direction 1112b from the concave chamber 1106 through auxiliary passages 1108 of the outer nozzle component 304 into an annular chamber 1110 in part defined by portions of the outer nozzle component 304. From the annular chamber 1110, the coolant flow enters the auxiliary passages 314 in the outer nozzle component 304 along direction 1112c and flows axially distal and radially inward toward the primary passage 310 at the distal end 308 of the nozzle 1100 along path direction 1112d before being redirected axially proximal and radially outward along path direction 1112e out of the outer nozzle component 304 via the exit holes 1120 for exhaustion away from the cutting surface at the distal end 308 of the nozzle 1100. In some embodiments, the coolant flow impingement inside of the inner nozzle component 302 along direction 1112b is radially outward and axially proximal, whereas the coolant flow impingement inside of the outer nozzle component 304 along direction 1112d is radially inward and axially distal.

Even though FIG. 10 depicts the fluid exit conduit as a plurality of holes 1120, the fluid exit conduit can also be constructed as a collar 320 described above with reference to FIGS. 3a-4. In fact, the outer nozzle component 304 of nozzle 1100 can be substantially the same as the outer nozzle component of any one of the double nozzles of FIGS. 3a-9 without departing from the spirit of the present invention. In addition, even though FIG. 10 depicts the holes 1120 as being sufficiently angled to cool at least a portion of the external surface of the outer nozzle component 304, in alternative embodiments, the holes 1120 can be less angled relative to the longitudinal axis of the nozzle 1100 such that the secondary fluid is exhausted from the nozzle 1100 without contacting the external surface of the outer nozzle component 304. Furthermore, a person of ordinary skill in the art understands that forming the fluid exit conduit as a set of one or more slotted holes 1120 can be easily adapted to any one of the nozzles described above with reference to FIGS. 3a-9.

In general, the cooling features described above with respect to various laser nozzle configurations, including the auxiliary passages 314, the at least one fluid exit conduit (e.g., in the form of a collar 320 or multiple exit holes 1120), the vent passages 602 and/or the additional auxiliary passages/cooling features in the inner nozzle component 302, are configured to deliver an impinging secondary fluid flow (e.g., a coolant fluid flow) on one or more interior surfaces of the nozzle proximate the primary passage 310 during material processing without intermingling with the beam path or a primary fluid flow in the primary passage 310. In some embodiments, the impingement locations within a laser nozzle are developed via multiple auxiliary passages as described above. For example, the impingement locations within a laser nozzle can be developed by oscillating the secondary fluid along one or more auxiliary passages disposed about the primary passage 310 such that the oscillating flow bounces from wall to wall within these auxiliary passages. In some embodiments, these cooling features (e.g., the passages, conduits and/or holes) for conducting a secondary fluid flow within a nozzle can be vented internally or externally. In some embodiments, these cooling features return the secondary fluid (e.g., gases and/or liquids) back upstream to conserve the fluid and ensure that the fluid does not reach the kerf. In some embodiments, the secondary fluid flow is separate/distinct from the primary fluid flow (e.g., a process gas flow). Alternatively, the secondary fluid flow can mingle with the primary fluid flow to aid in the cutting process.

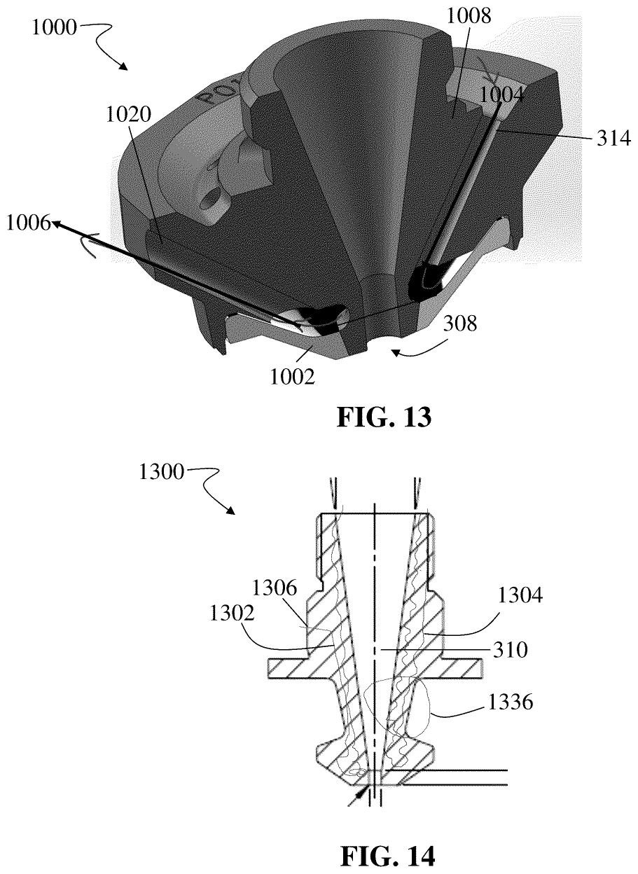

FIG. 13 shows a sectional perspective view of another nozzle 1000 of a laser processing system with yet another configuration of the fluid exit conduit, according to some embodiments of the present invention. In general, nozzle 1000 is a single nozzle having a single nozzle body. Nozzle 1000 includes at least one fluid exit conduit in the form of an exit hole 1020 for receiving and redirecting a secondary fluid from the set of multiple auxiliary passages 314 embedded in the nozzle 1000. Unlike nozzle 1100 of FIG. 10, where holes 1120 are formed (e.g., drilled) into the nozzle body, in nozzle 1000 the exit hole 1020 is formed by a cap 1002 attached to the distal end 308 of a nozzle body 1008 for cooperatively defining the exit hole 1020. Once attached to the nozzle body 1008, the cap 1002 is located opposite of a workpiece (not shown) and defines a portion of the exit hole 1020 that is configured to direct the secondary fluid away from the workpiece and/or recycle back into the laser processing system. This construction results in little to no flow disturbance near the workpiece.

In some embodiments, instead of the secondary fluid exiting toward the outer surface of the nozzle body 1008 to achieve impingement with the outer nozzle surface, the exit hole 1020 redirects the secondary fluid through the nozzle body 1008, along an exit path/direction 1006 that is more outward in comparison to the input path/direction 1004 of the secondary fluid via the auxiliary passages 314, such that no outer nozzle surface impingement is realized. In some embodiments, the exit hole 1020 is set to fluidly join the auxiliary passages 314 that are equidistant relative to each other such that the exit hole 1020 receives substantially all of the fluids from the auxiliary passages 314 prior to redirecting the fluids outward. In some embodiments, the exit hole 1020 is about 10-15% larger in diameter than that of each auxiliary passage 314 to decrease the velocity of the secondary fluid as it exits from the nozzle 1000. In some embodiments, the exit hole 1020 is clocked to (i.e., aligned with) an exhaust port in the cutting head (not shown) for recycling the secondary fluid being exhausted.

In operation, a secondary fluid (e.g., a cooling fluid) enters the auxiliary passages 314 to the cap 1002 and exits via the hole 1020 at least partially defined between the cap 1002 and the nozzle body 1008. More specifically, the secondary fluid can flow radially inward and axially distal along the input direction 1004 within an auxiliary passage 314 on one side of the nozzle body 1008 and leave radially outward and axially proximal along the exit direction 1006 via the exit hole 1020 disposed on the other side of the nozzle body 1008. Such a flow pattern results in a properly cooled nozzle while preventing the secondary fluid from interfering with a cut operation at the distal end 308 of the nozzle 1000.

FIG. 14 shows another nozzle 1300 of a laser processing system with auxiliary passages forming multiple tortuous/oscillating fluid flow paths 1302, 1304 within the body of the nozzle 1300, according to some embodiments of the present invention. Each of the tortuous fluid flow paths 1302, 1304 can be substantially adjacent to the primary passage 310 and create multiple impingement locations along the longitudinal axis of the nozzle body. The multiple impingement locations of each tortuous fluid flow path can comprise multiple internal surfaces of the associated auxiliary passages that generate an oscillating flow of the secondary fluid, such that the oscillating flow bounces from one internal surface to another internal surface along the auxiliary passages. In particular, as shown in FIG. 14, path 1302 represents a fluid flowing axially distal and radially inward toward the primary passage 310 in a tortuous manner prior to returning axially proximal and radially outward in a tortuous manner and exiting from the nozzle 1300 from a port 1306 on the side of the nozzle 1300 (e.g., exhausted to atmosphere). Path 1304 represents a fluid flowing axially distal and radially inward toward the primary passage 310 in a tortuous manner prior to returning upstream in a tortuous manner to mating components (not shown) to substantially conserve the fluid. At least one of the paths 1302, 1304 can circulate close to the primary passage 310 to within a critical region 1336 proximate the primary passage 310 to cool the primary fluid within the primary passage while being fluidly separated from the primary fluid. In some embodiments, the auxiliary passages defining path 1302 are fluidly isolated from the auxiliary passages defining path 1304, both sets of which are fluidly isolated from the primary passage 310.

The fluid supplied to one or both of paths 1302, 1304 can be from the primary passage 310 and/or another passage (not shown). In some embodiments, the fluid along path 1302 comprises a secondary fluid, such as a coolant gas (e.g., helium), that is exhausted from the side port 1306 of the nozzle 1300. In some embodiments, the fluid along path 1304 comprises a tertiary fluid that is different from the secondary fluid along path 1302. For example, the tertiary fluid can be a coolant liquid (e.g., water) that is circulated back to the cutting head for cooling, while the secondary fluid along the path 1304 is a coolant gas (e.g., air or helium). Thus, the nozzle 1300 of FIG. 14 can support dual coolant flows. In alternative embodiments, the same coolant fluid is supplied to both path 1302 and 1304. In some embodiments, the nozzle 1300 includes only one of the paths 1302, 1304. In some other embodiments, the nozzle 1300 further includes a set of additional auxiliary passages (e.g., similar to the auxiliary passages 314 of FIGS. 3a and 3b) and at least one fluid exit conduit (e.g., similar to the collar 320 of FIGS. 3a and 3b) to drive cooling flow along additional interior surface(s) of the nozzle 1300 proximate to the primary passage 310 in the distal region 308 of the nozzle 1300 but directed away from a cut. In general, any one or more of the cooling features described above with reference to FIGS. 3a-12 can be incorporated into the nozzle 1300 of FIG. 14.

As described above, the secondary fluid delivered to the nozzles of FIGS. 3a-13 can be a coolant fluid. In some embodiments, the secondary fluid has a composition different from that of the primary fluid conducted through the primary passage 310. In some embodiments, the secondary fluid is helium, air and/or water, while the primary fluid is nitrogen. In some embodiments, one or more of the cooling features of the nozzles described above, such as the auxiliary flow passage(s) 314, the at least one fluid exit conduit (e.g., collar 320 and/or holes 1020, 1120), cooling pockets 1102/spiral grooves 1103, and passages for creating the tortuous paths 1302, 1304, are created by one or more inserts disposed within the body of the corresponding nozzle. In some embodiments, these cooling features are created by one or more of press fit, machining grooves, friction welding, diffusion bonding, or three-dimensional printing. In some embodiments, the auxiliary flow passage(s) 314 have textured surfaces, such as from knurling, texturing, using three-dimensional printing techniques, etc. to enhance the cooling capacity of the fluids while being conducted through the auxiliary flow passage(s) 314 by increasing turbulence and impingement within the passages 314.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification. For example, it is within the spirit of the present invention to configure a laser nozzle to incorporate one or more of the cooling features described above with references to the nozzles of FIGS. 3a-13. More specifically, a nozzle can have any combination of one or more of the following features: the auxiliary passage(s) 314 for directing a cooling fluid to impinge an internal nozzle surface proximate the primary passage 310, at least one conduit (collar 320, holes 1020 or 1120) for exhausting the cooling fluid axially away/opposite from the direction of the primary fluid in the primary passage 310 and optionally flow over an external surface of the nozzle, the auxiliary passage(s) 314 constructed with constricted and expanded sections to manipulate thermal properties/conditions and promote cooling in certain areas as described above with reference to FIGS. 8a-9, auxiliary passages inside both the inner nozzle component and outer nozzle component of a double nozzle for thermally regulating the inner nozzle component followed by the outer nozzle component as described above with reference to FIGS. 10-12, auxiliary passages configured to provide one or more tortuous flow paths for the secondary fluid (and optionally a tertiary fluid) through the nozzle as described above with reference to FIG. 14, vent passages 602 to support additional cooling as described above with reference to FIGS. 6a-c, and optimized surface area ratios, angles, grooves and/or roughness of various flow passages described herein. Furthermore, it is well understood to a person of ordinary skill in the art that the cooling features of the double nozzles described above (e.g., with reference to FIGS. 3a-11) can be easily adapted to single nozzles.

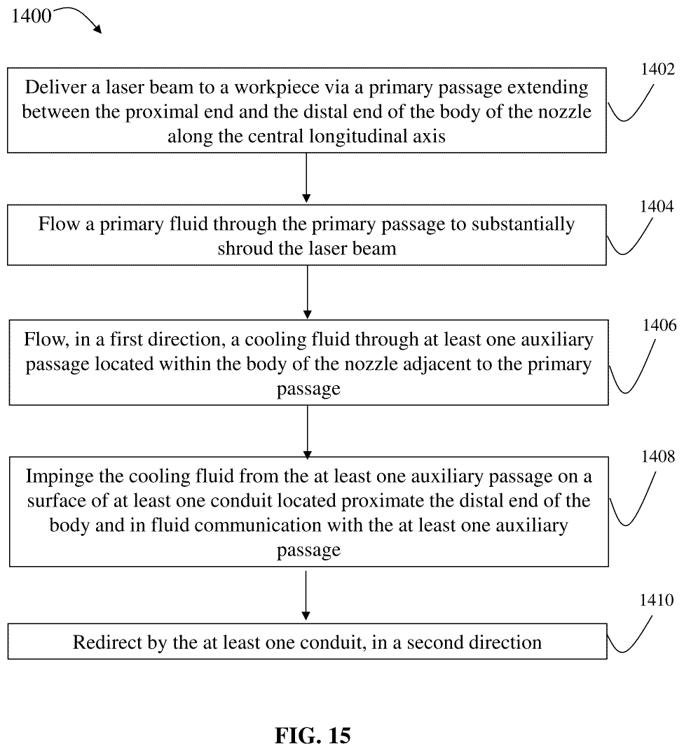

FIG. 15 shows an exemplary method 1400 for operating a laser processing system incorporating the laser nozzle 300 of FIGS. 3a and 3b, according to some embodiments of the present invention. Even though the method 1400 is described with respect to nozzle 300 of FIGS. 3a and 3b, a person of ordinary skill in the art understands that the method 1400 can be easily adapted to operate with any one of the nozzles described above with reference to FIGS. 4-13. As shown, method 1400 starts at step 1402 with a laser beam being delivered to a workpiece via the primary passage 310 of the nozzle 300 extending between its proximal end 305 and distal end 308 along central longitudinal axis B. At step 1404, a primary fluid (e.g., a cutting gas) is conducted through the primary passage 310 to substantially shroud the laser beam as it is being delivered to process the workpiece. At step 1406, a secondary fluid, which can be a cooling fluid, is conducted through the laser nozzle 300 via one or more of the auxiliary passages 314 in the first direction 322. The cooling fluid is delivered proximate the primary passage 310, but fluidly isolated from the primary fluid as well as the laser beam in the primary passage 310. At step 1408, as the cooling fluid travels axially distal and radially inward toward the primary passage 310 along the first direction 322, the cooling fluid ultimately exits the auxiliary passages 314 via their respective distal openings 318 and is deposited into a fluid exit conduit in the form of a collar 320. In alternative embodiments, the fluid exit conduit can be represented by a plurality of angled holes, such as holes 1120 of FIG. 10 or holes 1020 of FIG. 13. The cooling fluid is adapted to impinge on a surface of the collar 320 proximate the distal end 308 of the nozzle body.

At step 1410, upon entering the collar 320, the collar 320 is adapted to redirect the cooling fluid toward an exterior surface of the nozzle body in the second direction 324, which has an axial component along central longitudinal axis B that is substantially opposite from the axial component of the first direction 322 of the cooling fluid flow through the auxiliary fluid passages 314. As the cooling fluid is redirected axially proximal and radially outward away from the primary passage 310 along the second direction 324, the cooling fluid may or may not impinge on an external surface of the nozzle 300 to cool the external surface, depending on the angle 328 of the collar 320 relative to longitudinal axis B. As shown in FIGS. 3a and 3b, nozzle 300 has a relatively small angle 328 (i.e., less separation from longitudinal axis B) such that the cooling fluid is redirected into impingement with external nozzle surface 326. In contrast, as shown in FIG. 7, nozzle 700 has a larger angle 728 (i.e., more separation from longitudinal axis B) such that the cooling fluid is redirected away from the nozzle 700 without any external surface impingement.

In some embodiments, the collar 320 and/or the auxiliary passages 314 are configured to optimize the cooling ability of the cooling fluid flow at the critical region 336 proximate the primary passage 310. For example, the collar 320, in the form of an angled slot, can have a width 330 that is greater than the diameter 332 of each auxiliary passage 314. As another example, each auxiliary passage 314 can have a stepped construction with one or more expansion portions 902 for expanding the cooling fluid flow and one or more compression portions 904 for restricting the cooling fluid flow (as shown in FIG. 9), such that the cooling fluid is successively constricted as it flows downstream through the auxiliary passage 314. This results in a converging jet of cooling fluid that impinges on the surface of the collar 320 adjacent to the primary passage 310. Alternatively, each auxiliary passage 314 is tapered toward the distal end 308 of the nozzle to produce a similar cooling fluid dynamic (as shown in FIGS. 8a and 8b).

In some embodiments, the cooling fluid is vented via one or more off-axis vent passages 602 extending through the nozzle (as shown in FIGS. 6a-c), which further promotes the cooling ability of the cooling fluid. In some embodiments, the nozzle is a double nozzle, which includes the inner nozzle component 302 and the outer nozzle component 304, both of which can have cooling features in the form of auxiliary passages (as shown in FIG. 10). The cooling fluid can be conducted through auxiliary passages in the inner nozzle component 302 to cool the inner nozzle component 302 before being directed through the auxiliary passages 314 in the outer nozzle component 304 to cool the outer nozzle component 304. For example, as described with reference to FIGS. 10-12, the cooling features/passages in the inner nozzle component 302 can include a set of scooped pockets 1102 and/or spiral grooves 1103 and various fluid channels for conveying the cooling fluid in and out of the inner nozzle component 302.

In some embodiments, the cooling fluid is exhausted away from the nozzle, such as into atmosphere. In some embodiments, at least a portion of the cooling fluid is returned upstream to the laser processing system to conserve the cooling fluid. In some embodiments, a second, different cooling fluid is supplied to the laser nozzle via a second set of auxiliary passages configured to support the second cooling fluid flow, as described above with reference to FIG. 14. The second set of auxiliary passages can be fluidly separated from the first set of auxiliary passages 314 associated with the first cooling fluid flow and from the primary passage 310. The first and second sets of auxiliary passages can provide tortuous flow paths of different cooling fluids through the nozzle body without comingling with each other or with the primary fluid.

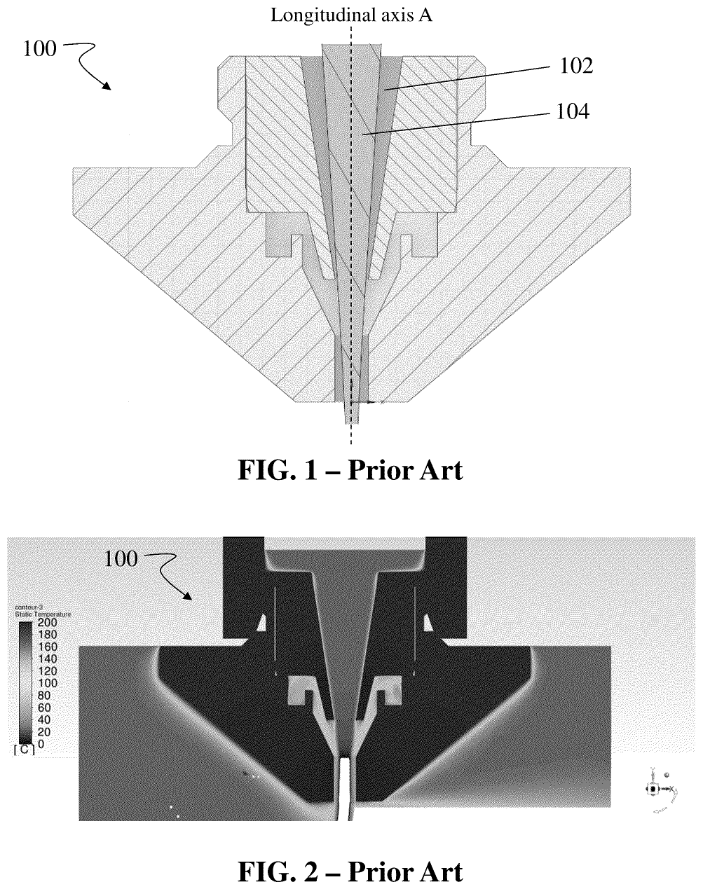

The laser nozzles of the present invention offer many benefits over prior art nozzle, such as nozzle 100 of FIGS. 1 and 2. The various laser nozzles and methods of operation described herein allow cheaper fluid(s) to be used for the coolant flow due to isolation of the coolant flow in the auxiliary passages from the cutting flow in the primary passage, which means that the cooling fluid can be cheaper/different from the cutting fluid, thus reducing operating costs. Due to such isolation, the cooling fluid does not contaminate the cutting fluid and the same cooling fluid can be used to decrease the temperature of the nozzle internally and then further reduce the temperature of the nozzle with external cooling. In addition, a higher heat capacity fluid can be utilized as a cooling fluid if it is not used as a cutting fluid. Also, due to the fluid isolation, the auxiliary passages and optical passages are protected from any molten metal generated from cutting a metallic workpiece. Furthermore, the cooling fluid can be used to cool multiple nozzle components (e.g., both inner and outer nozzle components of a double nozzle). Overall, the apparatuses and methods of the precent invention can offer improved nozzle life and performance via improved thermal regulation of the nozzle.

1. A nozzle for a laser processing system, the nozzle comprising:
a body defining a proximal end, a distal end and a central longitudinal axis extending therebetween;
a primary passage extending between the proximal end and the distal end of the body along the central longitudinal axis, the primary passage configured to flow a primary fluid along with a laser beam from the laser processing head to a workpiece;
at least one auxiliary passage located within the body of the nozzle adjacent to the primary passage while substantially fluidly isolated from the primary passage; and
at least one conduit located proximate the distal end of the body and in fluid communication with the at least one auxiliary passage;
wherein the at least one auxiliary passage is configured to flow a secondary fluid through the body of the nozzle in a first direction to impinge on a surface of the at least one conduit that is proximate the primary passage, and
wherein the at least one conduit is configured to redirect the secondary fluid toward an exterior surface of the body in a second direction, an axial component of the first direction along the central longitudinal axis being substantially opposite of an axial component of the second direction along the central longitudinal axis.

2. The nozzle of claim 1, wherein the at least one auxiliary passage is oriented to direct the secondary fluid to flow radially inward toward the central longitudinal axis and axially distal toward the distal end of the nozzle.

3. The nozzle of claim 1, wherein the at least one conduit is configured to redirect the secondary fluid from the at least one auxiliary passage radially outward from the central longitudinal axis and axially proximal toward the proximal end of the nozzle.

4. The nozzle of claim 3, wherein the at least one conduit is configured to redirect the secondary fluid flow outward and proximal at an angle between about 10 degrees and about 80 degrees relative to the central longitudinal axis.

5. The nozzle of claim 1, wherein the at least one conduit is a collar disposed around a circumference of the nozzle body proximate to the distal end of the body, the collar being in fluid communication with the at least one auxiliary passage.

6. The nozzle of claim 1, wherein the at least one conduit comprises at least one hole in fluid communication with the at least one auxiliary passage.

7. The nozzle of claim 1, wherein the at least one conduit defines an angled slot between the distal end of the nozzle and a portion of the exterior surface of the nozzle.

8. The nozzle of claim 7, wherein the slot has a width that is greater than a diameter of the at least one auxiliary passage.

9. The nozzle of claim 8, wherein a radius of curvature of a bottom region of the slot is less than about 55% of the width of the slot.

10. The nozzle of claim 1, wherein an area of the exterior surface of the body in contact with the secondary fluid redirected by the at least one conduit is greater than or equal to about 30% of a total external surface area of the nozzle.

11. The nozzle of claim 10, wherein the secondary fluid comprises a coolant fluid and the area of the exterior surface in contact with the secondary fluid extracts greater than about 0.05 watts/cubic-feet-per-min of coolant fluid flow.

12. The nozzle of claim 1, wherein the at least one auxiliary passage includes one or more expansion portions and one or more compression portions, each expansion portion shaped to allow the secondary fluid flow to expand and each compression portion shaped to constrict the secondary fluid flow.

13. The nozzle of claim 12, wherein the one or more compression portions or the one or more expansion portions of the at least one auxiliary passage are defined by one or more tapered or stepped configurations.

14. The nozzle of claim 13, wherein each compression portion is located proximate the primary passage and shaped to produce a converging jet of the secondary fluid adapted to impinge on the surface of the at least one conduit proximate the primary passage.

15. The nozzle of claim 1, wherein the at least one conduit blocks a line of sight between an outlet of the at least one auxiliary passage and an intersection between a laser beam delivered by the primary passage and the workpiece.

16. The nozzle of claim 1, wherein the at least one auxiliary passage forms a tortuous path through the body of the nozzle substantially adjacent to the primary passage while creating multiple cooling impingement locations within the nozzle body, wherein the multiple cooling impingement locations are isolated from the primary passage.

17. The nozzle of claim 16, wherein the multiple cooling impingement locations comprise a plurality of internal surfaces of the at least one auxiliary passage to form an oscillating flow of the secondary fluid, such that the oscillating flow is configured to bounce from one internal surface to another internal surface along the auxiliary passage.

18. The nozzle of claim 1, wherein the at least one auxiliary passage comprises a plurality of auxiliary passages distributed about the primary passage and substantially fluidly isolated from the primary passage.

19. The nozzle of claim 18, further comprising an inner nozzle component and an outer nozzle component, wherein a first subset of the plurality of auxiliary passages are located within the inner nozzle component and configured to direct internal impingement of the secondary fluid within the inner nozzle component for thermally regulating the inner nozzle component.

20. The nozzle of claim 19, wherein the first subset of auxiliary passages comprises cooling features in the form of at least one of a spiral groove, fin, arcuate surface, scallop, scooped pocket or textured surface located within the inner nozzle component.

21. The nozzle of claim 19, further comprising a second subset of the auxiliary passages disposed in the outer nozzle component and in fluid communication with the at least one conduit, the second subset of auxiliary passages configured to direct the secondary fluid, received from the first subset of auxiliary passages, to impinge within and thermally regulate the outer nozzle component.

22. The nozzle of claim 18, wherein one or more auxiliary passages in the plurality of auxiliary passages are configured to return at least a portion of the secondary fluid back upstream to conserve the secondary fluid.

23. The nozzle of claim 1, wherein the secondary fluid has a composition different from that of the primary fluid.

24. The nozzle of claim 1, wherein at least a portion of the secondary fluid is helium or air.

25. The nozzle of claim 1, wherein the at least one auxiliary passage or the at least one conduit is created by an insert disposed within the body of the nozzle.

26. The nozzle of claim 1, wherein the at least one auxiliary passage or the at least one conduit is created by one or more of press fit, machining grooves, friction welding, diffusion bonding, or three-dimensional printing.

27. The nozzle of claim 1, wherein the primary passage has a cross-sectional area of between about 1.5 mm² and 5 mm², and the at least one auxiliary passage has a cross-sectional area of between about 10 mm² and 25 mm².

28. The nozzle of claim 1, wherein a ratio of a cross-sectional area of the primary passage to a cross-sectional area of the at least one auxiliary passage is about 0.5 or less.

29. The nozzle of claim 1, further comprising at least one vent passage disposed about the primary passage and located at the proximal end of the body of the nozzle, the at least one vent passage configured to vent at least a portion of the secondary fluid to atmosphere.

30. The nozzle of claim 1, wherein a first subset of the at least one auxiliary passage are configured to conduct the secondary fluid through the body of the nozzle and a second subset of the at least one auxiliary passage are configured to conduct a tertiary fluid through the body of the nozzle.

31. The nozzle of claim 30, wherein the secondary fluid comprises a first cooling fluid and the tertiary fluid comprises a second cooling fluid.

32. The nozzle of claim 31, wherein the first cooling fluid is a gas and the second cooling fluid is a liquid.

33. The nozzle of claim 31, wherein the second cooling fluid is circulated back to the laser processing head while the first cooling fluid is exhausted from the nozzle to atmosphere.

34. A method for cooling a nozzle of a laser processing system, the nozzle comprising a body that defines a proximal end, a distal end and a central longitudinal axis extending therebetween, the method comprising:
delivering a laser beam to a workpiece via a primary message extending between the proximal end and the distal end of the body of the nozzle along the central longitudinal axis;
flowing a primary fluid through the primary message to substantially shroud the laser beam;
flowing, in a first direction, a cooling fluid through at least one auxiliary passage located within the body of the nozzle adjacent to the primary passage, the cooling fluid flow being substantially isolated from the primary fluid flow;
impinging the cooling fluid from the at least one auxiliary passage on a surface of at least one conduit located proximate the distal end of the body and in fluid communication with the at least one auxiliary passage; and
redirecting by the at least one conduit, in a second direction, the cooling fluid toward an exterior surface of the body of the nozzle, wherein the second direction has an axial component along the central longitudinal axis that is substantially opposite from an axial component of the first direction of the cooling fluid flow through the at least one auxiliary passage.

35. The method of claim 34, wherein the first direction of the cooling fluid flow through the at least one auxiliary passage comprises a radial component directed radially inward toward the central longitudinal axis and the axial component of the first direction directed distal toward the distal end of the nozzle.

36. The method of claim 34, wherein the second direction of the cooling fluid redirected by the at least one conduit comprises a radial component directed radially outward from the central longitudinal axis and the axial component of the second direction directed proximal toward the proximal end of the nozzle.

37. The method of claim 34, wherein the at least one conduit defines an angled slot between the distal end of the nozzle and a portion of the exterior surface of the nozzle.

38. The method of claim 37, wherein the slot has a width that is greater than a diameter of the at least one auxiliary passage.

39. The method of claim 34, wherein flowing the cooling fluid through the at least one auxiliary passage comprises expanding the cooling fluid flow via at least one expansion portion of the auxiliary passage and constricting the cooling fluid flow via at least one compression portion of the auxiliary passage.

40. The method of claim 39, wherein the at least one compression portion is located adjacent to the primary passage and downstream from the at least one expansion portion, such that the compression portion produces a converging jet of the cooling fluid to impinge on the surface of the at least one conduit.

41. The method of claim 34, wherein redirecting by the at least one conduit the cooling fluid comprises redirecting the cooling fluid to impinge on an exterior surface of the body of the nozzle.

42. The method of claim 34, wherein redirecting by the conduit the cooling fluid comprises redirecting the cooling fluid radially outward and axially proximal at an angle of between about 10 degrees and about 80 degrees relative to the central longitudinal axis.

43. The method of claim 34, further comprising venting, via at least one vent passage disposed about the primary passage at the proximal end of the body of the nozzle, at least a portion of the cooling fluid to atmosphere.

44. The method of claim 34, wherein the nozzle comprises an inner nozzle component and an outer nozzle component, and wherein the at least one auxiliary passage comprises a first subset of auxiliary passages located in the inner nozzle component and a second subset of auxiliary passages located in the outer nozzle component.

45. The method of claim 44, further comprising:
providing the cooling fluid to the first subset of auxiliary passages in the inner nozzle component to cool the inner nozzle component;
conducting the cooling fluid radially outward from the inner nozzle component to the outer nozzle component; and
flowing the cooling fluid through the at least one auxiliary passage in the first direction and through the at least one conduit in the second direction to cool the outer nozzle component.

46. The method of claim 34, further comprising returning at least a portion of the cooling fluid back upstream to conserve the cooling fluid.

47. The method of claim 34, further comprising forming a plurality of tortuous fluid flow paths through the body of the nozzle adjacent to the primary passage by respective ones of a plurality of subsets of the at least one auxiliary passage, each of the plurality of tortuous fluid flow paths creating multiple internal cooling impingement locations isolated from the primary passage.

48. The method of claim 47, further comprising flowing different cooling fluids through the plurality of tortuous fluid paths, wherein the plurality of subsets of auxiliary passages are fluidly isolated from each other and from the primary passage.

49. The method of claim 47, wherein one of the plurality of cooling fluids is a liquid and another one of the plurality of cooling fluid is a gas.
